(19) United States
(12) Patent Application Publication
(10) Pub. No.: US 2003/0158809 A1
(43) Pub. Date: Aug. 21, 2003

(54) Reloadable rights plan for preferred and common stock

(76) Inventors: William J. Carney, Atlanta, GA (US); Leonard A. Silverstein, Atlanta, GA (US)

Correspondence Address: MCKENNA LONG & ALDRIDGE LLP, 1900 K STREET, NW, WASHINGTON, DC, 20006, US

(21) Appl. No.: 10/291,796

(22) Filed: Nov. 12, 2002

Related U.S. Application Data
(60) Provisional application No. 60/331,163, filed on Nov. 9, 2001.

(51) Int. Cl. G06F 17/60

(52) U.S. Cl. 705/37

(57) ABSTRACT

A method of drafting preferred stock and common stock shareholder rights plans that dilute the investment of an uninvited bidder for control of a company, that provides for issuance of rights to purchase equity securities at a discount price, void in the hands of the bidder, that issues new rights continuously once a previous right has become exercisable and increases the number of shares issuable on exercise as the bidder's percentage ownership increases. Additionally, a method of exercising preferred stock and common stock rights plans that provides for exercise of rights to purchase equity securities after a stock acquisition date on which a person becomes owner of a specified percentage of shares, at discounts from the current market value of the stock, wherein the rights continuously reload to holders of shares and unexercised previous rights once a new stock acquisition date occurs.

This application claims the benefit of U.S. Provisional Patent Application No. 60/331,163, filed on Nov. 9, 2001, which is hereby incorporated by reference for all purposes as if fully set forth herein.

### BACKGROUND OF THE INVENTION

1. Field of the Invention

The present invention relates to a shareholders rights plan for deterring hostile company takeovers. More specifically, to a reloadable rights plan for preferred stock rights plans and common stock rights plans.

2. Discussion of the Related Art

Thousands of companies have adopted shareholder rights plans. These plans were initiated and promoted by some of Wall Street's best known corporate law firms, and their models have been almost slavishly followed by other lawyers across the country.

From the beginning, rights plans were seen as the most powerful of takeover defenses. The Delaware Chancery Court has apparently viewed them as preclusive deal killers that must be redeemed when threats are no longer serious. Many financial economists undertook studies of the stock price effects of these plans, and generally concluded that these plans were indeed powerful takeover defenses. Some have attributed the decline in the number of hostile takeovers to the widespread adoption of rights plans. To the inventors' knowledge, no one has systematically examined the operation of rights plans. We do so herein and present problems with related art rights plans.

The related art rights plans commonly called a poison pill will make many bidders nauseous, but it is not fatal in all cases. Under the most plausible scenario for a related art rights plan, it adds an increased acquisition cost of 6% to 12%, well within typical reservation prices in hostile takeovers.

Lawyers, not investment bankers, typically create these plans. They are elaborate contracts, reflecting the accumulated wisdom of experienced corporate lawyers. Their complexity may explain why so little commentary has appeared about their workings. The event studies that have examined their impact are virtually devoid of any discussion of the details of their operation. It is possible that economists are deterred from this exercise by the legal complexity these plans present.

Accordingly, the inventors provide a brief explanation of the mechanics of the related art rights plan. Our primary focus is on the “flip-in” feature of rights plans, which is designed to prevent a bidder from gaining either a significant toe-hold or actual control of a target.

Also, the inventors examine the impact of the related art rights plan on a bidder's costs. This examination reveals that related art rights plans are less effective than conventional wisdom suggests at deterring hostile bidders because the dilution that the bidder suffers has been examined in a static model that ends with the dilution of the bidder's initial investment.

However, a dynamic model, in which the bidder completes the acquisition of the target after suffering dilution produces quite a different impression. For example, the ability of the related art rights plan to add to a bidder's costs, and thus to the amount received by target shareholders, is limited to the amount spent by the bidder in reaching the triggering ownership level—typically 15% of the target's outstanding shares. Additionally, the mechanics of the related art rights plan mean that the bidder will lose only a fraction, rather than all, of that initial investment. Finally, a poison pill is a tablet, rather than a timed release capsule—once taken, it provides relief for only a moment, and the chances of further relief are problematic.

Referring to FIG. 1, the operation of the related art rights plans will now be explained. Rights are issued as pro rata distributions to all common stockholders of a company. The right is typically the right to purchase one unit of a new series of preferred stock of the company. The preferred stock unit has rights that are essentially equivalent to those of the common, with minor distinctions. But these rights are exercisable at the projected “long term value” of the common stock—at the end of the ten year life of the rights—a price typically three to five times higher than the current market price of the common stock. To reach these valuations, financial advisers of the adopting company's board are required to make heroic assumptions about growth rates, such as 17.7% per year compounded annually for the ten year life of the rights plan.

These rights are initially “stapled” to the common stock in the sense that they trade with the common, and are represented only by the common stock certificates, and are not immediately exercisable on issue. The rights separate from the common stock certificates on a “Distribution Date,” which occurs when a bidder (an “Acquiring Person”) appears, either by acquiring a substantial block, typically at least 15% (the “Stock Acquisition Date”) or by making a tender offer for a slightly larger block, typically 30%. Generally, the distribution date occurs ten days after the date of first announcement that the bidder either acquires the triggering amount of shares or announces a tender offer that could result in such ownership. At this point the rights certificates issue and become freely transferable apart from the common stock. Prior to the Stock Acquisition Date the rights are redeemable for a nominal amount.

On the Stock Acquisition Date, the power of the company's board of directors to redeem the rights generally terminates. This prevents a bidder that has taken a substantial position in a target's shares from waging a proxy fight to replace the board with new members who will redeem the rights, using its newly acquired shares to win the contest.

More importantly, at this point, the rights are no longer exercisable to acquire a preferred stock unit at an unrealistic price—it was never contemplated that the preferred stock rights would be exercised on their original terms. In the event the bidder acquires a specified substantial block and becomes an Acquiring Person, the rights “flip in” and become exercisable for the target's common stock (the “flip-in”) at a discount, typically 50% of current market value. The exercise price for the preferred stock becomes the exercise price for multiple shares of common stock. Thus, if the exercise price were $100 per unit of preferred, the holder of a right now has the right to purchase common stock with a market value (pre-exercise) of $200 for $100. Flip-in rights, therefore, establish a fixed “gain” for stockholders, whereas conventional stock options allow for an unlimited gain. The key to the operation of this plan is discrimination against the bidder—rights are void in the bidder's hands.

Poison pill rights have an important anti-destruction provision—a merger between the bidder and the target does not destroy the rights—they “flip over” to become exercisable for the bidder's common stock, on the same bargain basis as the flip-in rights—a 50% discount, using the same exercise price. Thus, the dilution of the bidder's shareholders is identical, whether the flip-in or flip-over rights are triggered.

The impact of a related art rights plan and some of the problems associated therewith will now be explained by reviewing how a related art rights plan would operate if triggered. Beginning with a simple observation, a rights plan can only dilute the investment that a bidder has already made when it crosses the threshold that triggers the rights. If the threshold is 15% and the bidder's cost for this investment is not disproportionately low, the maximum that can be taken from a bidder through dilution at this stage is its 15% investment, hardly enough, by itself, to deter a determined bidder prepared to pay a premium for a target it perceives to be undervalued. Because most rights plans only provide a 50% discount from market price, rights plans will not appropriate all of the bidder's initial investment.

One of the difficulties in examining the operation of rights plans is that none have operated, at least since Sir James Goldsmith triggered the flip-over plan of Crown Zellerbach Corporation in the 1980s (which was less effective than modern flip-in or flip-over plans). No flip-in plan has ever been deliberately triggered, although there was a close call in one case, and there have been a few other inadvertent triggering events. Several uncertainties present themselves in assessing the impact of the related art rights plan.

For example, if the rights plan flips in, will rights holders exercise immediately or will they wait until immediately before expiration, as rational holders of conventional options would do? While shares should be valued on a fully diluted basis in efficient markets, uncertainty about the target's receipt of cash and the investment or disposition by the target of those funds could influence the value of the shares in the market place, and therefore the cost of acquisition.

These problems appear less intractable than these questions suggest. Unlike conventional options, poison pill rights are not rights to purchase a specified number of shares at a specified price. Rather, virtually all of the conventional preferred stock plans employ a formula for the flip-in rights: regardless of the actual exercise price and the actual market price it is the right to buy shares with a market value double the exercise price. For example, if the exercise price is $40, the market value of shares to be purchased is $80, regardless of the market price. Thus, the dollar amount of dilution created by this kind of option is constant, rather than varying with the current market value of the shares at the time of exercise.

There is no incentive to hold the rights until immediately before expiration if the shares can be resold immediately after exercise, which permits the capture of the full benefit of the flip-in right. Because shareholders (other than the bidder) can gain immediately from the exercise of the flip-in rights, we assume immediate exercise in the examples below. This is particularly likely in the context of a hostile takeover battle where arbitrageurs will want to either tender shares to the bidder or dispose of their shares (including those subject to flip-in rights) as soon as possible after a bid fails. On the other hand, individual shareholders may not be so quick to exercise because of transaction costs in raising funds to exercise, a reluctance (even short-term) to put so many eggs in one basket, or simple inertia. Nevertheless, the dilutive effects of the rights plan of the related art remain similar regardless of the time of exercise, assuming that a bidder's tender offer for additional shares would require tender of the associated rights.

The other problem with predicting the effect of the triggering of rights is predicting what will become of the proceeds from the exercise of the rights. There is no reason to expect the target to have any positive net present value projects in which to invest the proceeds when received. By “positive net present value” we mean any project where the discounted present value of the returns from the project exceeds the discounted present value of the investments in the project, using the firm's cost of capital as the discount rate. The proceeds will be several times the current equity of the company because the exercise price has been set at a multiple of the value of the common stock at the time of distribution. Any funds received can, in all likelihood, only be invested by the target in negative net present value projects. Nevertheless, for our calculations herein we simply assume that the proceeds add to the value of the target on a dollar for dollar basis (variances based on expectations of negative net present value projects will probably be small enough to have little impact on the analysis that follows). In some cases target companies have distributed surplus funds to shareholders (other than the bidder) through selective share repurchases, which have modest effects on the results shown below.

Next, an example of calculating the bidder's dilution is provided. The discussion of bidder dilution begins with a caution, as it is only half the picture. Too often analysis stops with an observation that a hostile bidder's initial investment will be massively diluted by crossing the threshold that permits exercise of the flip-in rights. While this is true, it gives only a partial picture of the costs imposed by related art rights plans on a determined bidder, because it uses a static rather than a dynamic analysis.

As noted earlier, in approximately two-thirds of the all related art rights plans the flip-in rights are triggered by a 15% stock acquisition. If a bidder's initial investment were totally destroyed by the exercise of the rights, the rights plan has added only 15% to the bidder's costs of a total acquisition. Dilution is never 100% because the bidder remains the owner of some (diminished) percentage of the outstanding shares, so the bidder's actual losses (added costs) will be somewhat less. Analysis begins by examining the operation of a typical related art preferred stock rights plan, with flip-in rights triggered at the 15% level and with the rights exercisable at a 50% discount from market price. Assuming that rights have been issued at an exercise price that is four times the current (pre-bid) market price of the common stock, it will be shown that triggering flip-in rights at the minimum ownership level is a dominant strategy. This is because triggering with the bidder owning larger amounts always places more of the bidder's investment at risk, at least until unrealistically high levels of ownership are attained.

The inventors will explore ways to increase the bidder's dilution with conventional rights plans for the purpose of demonstrating the limit of these plans. Table 1 below sets out the assumptions in our examples:

TABLE 1
Assumptions for Standard Preferred Stock Rights Plan

| | |
|---|---|
| Target shares outstanding | 1,000,000 |
| Pre-bid market price per share: | $10.00 |
| Bidder's per share cost for the first 15%: | $15.00 |
| Expected takeover bid price per share: | $15.00 |
| Exercise price for preferred stock rights: | $40.00 |
| Assumed market value per target shares for calculating | $15.00 |
| common stock acquisition price: | |
| Flip-in trigger: | 15% |
| Flip-in discount: | 50% |
| Shares issuable per right if the market price is $15/share | 5.33 |
| (80/15): | |

The operation of the related art flip-in plan is now described, assuming that a bidder acquires the minimum number of shares and triggers the rights so shares may now trade on a fully diluted basis. Because the bidder receives no rights and suffers dilution, its percentage ownership is severely diluted. But, unlike prior analysis, it is assumed that the bidder is determined, and then proceeds to acquire the remaining public shares at the takeover premium for the pre-bid value of the target (50%).

Table 2 shows the bidder's costs of a complete acquisition using these assumptions:

TABLE 2
Bidder's Cost of Acquisition Using a Minimum Purchase With
a Preferred Stock Rights Plan

| | |
|---|---|
| Bidder's initial acquisition of 150,000 shares at | $2,250,000 |
| $15.00/share | |
| Rights flip in for 5.3333333 shares for 850,000 rights | |
| Shares Outstanding: | |
| New shares | 4,533,333 |
| Original shares | 1,000,000 |
| Total shares | 5,533,333 |
| Proceeds of exercise: (850,000 × $40): | $34,000,000 |
| Market's estimate of value of target: | $49,000,000 |
| Value per fully diluted share ($49,000,000/5,533,000): | $8.855421 |
| Value of bidder's 150,000 shares: | $1,328,313 |
| Bidder's dilution losses: | $921,688 |
| Bidder's cost for remaining shares (5,383,333 × $8.855) = | 47,671,688 |
| Total Cost to Bidder: | $49,921,688 |

If it is assumed that the proceeds of exercise of the rights have been retained by the target, the bidder can capture the $34,000,000 proceeds by declaring a dividend once it has gained complete ownership of the target, leaving a net cost of $15, 921,688. The dilution loss represents 41% of the bidder's initial investment. Put another way, it represents 9.2% of the target's pre-bid value, or 6.1% of the bidder's original estimate of the cost of an acquisition, absent the rights plan. Premiums of this general magnitude are supported by studies of the premiums added to the cost of acquisitions by the presence of related art rights plans.

The expected cost to a bidder of the presence of a related art rights plan is the bidder's cost per share times the number of shares held by the bidder, minus the post-issue (fully diluted) market value of the target's shares held by the bidder, which is a function of the market value of the entire company divided by the post-issue number of target shares. This can be expressed as:

$$L = ma - \frac{( mx + p )}{x + d} ( a ) . \qquad Equation ( 1 )$$

Where L=bidder's loss through dilution; m=pre-trigger market price; a=bidder's share ownership at the time flip-in rights are triggered; x=shares outstanding before dilutive issuance; d=number of shares issued in dilutive distribution; p=proceeds from exercise of rights (x-a)e; and e=exercise price of rights.

This model expresses the obvious truth that the bidder's loss can be no more than the bidder's investment in the target at the time the rights become exercisable, ameliorated by the new value received upon exercise of the rights and limited by the fact that the bidder will retain some percentage ownership in the company absent issuance of an infinite number of new shares at a zero exercise price, as would be the case with a discriminatory stock dividend.

The discussion thus far has not considered the impact on the bid premium of the target's receipt of the exercise price for the rights. Accordingly, the effect of the related art rights plans on the size of the bid premium is examined. If, using the example in Table 2, the proceeds from the exercise of the rights are $34,000,000 (See Table 2), the total value of the target, including the takeover premium, will be approximately $49,000,000. If the bidder persists in offering a premium of $5 million for the entire company, the premium is now only approximately 10% of the post-announcement value of the target, or 11.3% of target value without a bid premium ($44,000,000). Whether this dramatic percentage reduction in the premium is sufficient to defeat a bid depends on whether the bidder can convince the remaining shareholders that the premium for the target's core business asset is still 50%. In short, the market value of the target's core business was $10 million before the takeover bid started, and will not exceed $15 million in a takeover.

Reducing the exercise price to zero can double the dilution of the bidder. While a zero exercise price, equivalent to a discriminatory stock dividend, may create problems from a legal capital perspective, it demonstrates the limits of the related art rights plans. Because of the difficulties with a zero exercise price, the impact on dilution of various exercise prices is greater than zero. If the exercise price were zero, Equation (1) would be modified as follows:

$$L = ma - \frac{( mx )}{x + d} ( a ) . \qquad Equation ( 2 )$$

Table 3 demonstrates that even zero price plans with more shares issued per right have only a modest impact on the power of a rights plan to deter bidders. Table 3 shows increasing levels of dilution as the exercise price declines:

TABLE 3
Bidder's Dilution at Varying Discounts

| Discount from | Bidder's | Investment | Added to |
|---|---|---|---|
| Market Price | Dilution Losses | Lost | Cost |
| 50% | $921,687 | 41% | 6% |
| 60 | 1,106,024 | 49 | 7 |
| 70 | 1,290,361 | 57 | 9 |
| 80 | 1,474,699 | 66 | 10 |
| 90 | 1,659,036 | 74 | 11 |
| 100 | 1,843,373 | 82 | 12 |

Thus, in our minimum acquisition example, the bidder's losses through dilution are doubled as a percentage of the initial investment if the rights are exercisable at a 100% discount, compared to the dominant model. This represents approximately 18% of the pre-bid value of the target, hardly an insurmountable barrier to typical bids, where premiums have averaged 50% or more in hostile bids. The conclusion must be that rights exercisable at 50% of market value remove much of the power of a rights plan. However, related art rights plans with little or no exercise price are not observed.

Introducing a second complication in order to examine the impact of a creeping tender offer, the assumption of a single price for the target's shares throughout a takeover is relaxed. It has been assumed that the bidder has paid the full takeover premium for all shares acquired, which maximizes the bidder's investment available for dilution. In most cases the bidder will quietly acquire shares in the market, in a “creeping tender offer,” at a price the bidder hopes will not be influenced by any signal of an impending takeover. It is assumed, for purposes of this example, that the bidder is able to acquire 10% of the target's shares at a price uninfluenced by the signal and at this point the bidder files its Schedule 13D (which it is required to file within 10 days after it has acquired beneficial ownership of 5% of the target company's outstanding shares, during which period it can increase its ownership) revealing its intent to take control, so that additional purchases will reflect the full takeover premium. The effect of this is to reduce the bidder's initial investment below the amount stated in Equations (1) and (2) and in Table 1 in the example by $500,000. This further weakens the dilutive power of related art rights plans.

Courts and commentators have mentioned the possibility that a rights plan could be defeated through a tender offer for a high minimum number of shares and rights so that fewer rights would remain outstanding to create dilution. At the same time, the bidder's investment that is subject to dilution is much larger, and it is this effect that dominates over a very broad range. Table 4 demonstrates this effect at very high levels of ownership—levels that are unrealistic goals for a hostile tender offer. In all other aspects the assumptions of Table 1 continue to apply.

TABLE 4
Bidder's Dilution When Shares are Issued at Higher Levels of Bidder
Ownership

| Bidder's | Bidder's Dilution | Percent of Investment |
|---|---|---|
| Ownership | Losses | Lost |
| 20% | $1,215,100 | 40.5% |
| 30 | 1,774,513 | 39.4 |
| 40 | 2,285,537 | 38.0 |
| 50 | 2,727,055 | 36.4 |
| 85 | 2,833,057 | 22.2 |
| 90 | 2,347,583 | 17.4 |
| 95 | 1,493,285 | 10.5 |
| 97 | 1,003,331 | 6.9 |
| 98 | 708,349 | 4.8 |

Thus, in absolute dollar losses through dilution the bidder would have to acquire 98% of all target shares in order to reduce dilution losses below those imposed by simply acquiring the 15% minimum amount required to trigger the rights. The first lesson for bidders, then, is to minimize the investment made that triggers the rights. Courts that have viewed a high minimum ownership condition for a tender offer as a way around the rights have simply failed to do any calculations.

Other variations from the related art rights plans can alter the amount of dilution imposed on the acquirer, for example, if more or less shares are issuable per right. The inventors have calculated this plan's effects on a bidder's dilution at various levels, beginning with one share per right. This calculation has relevance because many of the related arts rights plans permit the target (in the absence of sufficient authorized but unissued shares to fully honor the rights) to exchange the rights for one share per right. If, for example, rights are honored by the issuance of a single share per right for no consideration, the bidder's dilution loss is $1,033,784, or 46% of its $2,250,000 investment. Table 5 shows the bidder's losses through dilution at various levels of share issuance to the holders of the remaining 850,000 shares assuming a purchase at 50% of market value. These calculations should be compared with the effective rate shown in previous examples, which was 5.333 shares per right, given assumptions about market prices. All other assumptions remain unchanged from those used in Table 1.

TABLE 5
Bidder's Dilution When Shares are Issued at the Threshold Level That
Triggers Rights

| No. Shares | Bidder's Dilution | Percent of Investment |
|---|---|---|
| Issued per Right | Losses | Lost |
| 4 | $579,545 | 25.8% |
| 8 | 1,307,692 | 58.1 |
| 10 | 1,476,316 | 65.6 |
| 12 | 1,593,750 | 70.8 |
| 16 | 1,746,575 | 77.6 |
| 32 | 1,989,362 | 88.4 |

Rights plans typically have a ten year life, and many are not amended or updated during that term. But if the target's stock price rises during this period, it can seriously diminish the dilutive impact of the rights. The exercise price was set at the start of the period, and typically will not be adjusted. The related art rights plans permit exercise at a price that is three to five times the current market price of the target's shares at the time of adoption. But if the market price of the target's shares doubles during the life of the rights, the exercise price may drop to two times the current market value of the target's shares, or less. Thus, using the numbers in Table 4, if the market price rises from $10 to $20, an exercise at $40 produces four shares of common stock rather than the original eight. Further, the bidder's dilution declines as a percentage of the total value of the target. While a board can adjust the exercise price, and thus the number of shares of common stock to be purchased, prior to a distribution date most boards fail to do this, and once a bidder has triggered the rights this power no longer exists in related arts plans.

The increments to a bidder's cost added by a standard poison pill appear quite modest in the previous examples. But these polar examples may have failed to capture some increases in these costs that are possible. For example, what happens if the flip-in rights become exercisable at points in between 15% and 90% ownership? Table 4 contains some interim positions—flip-in rights set at thresholds of 20-50% which demonstrate that meaningful dilution can be obtained by raising the threshold for the exercise of these rights.

The difficulty with a higher threshold for the exercise of flip-in rights is that it allows bidders to obtain a more substantial ownership position without fear of dilution. This can block a future negotiated transaction with a third party, as well as form a strong base for proxy fights.

One possible solution to this problem is to set the ownership level at one level for the separation of the rights from the common stock and the termination of the board's power to redeem, and at another level for triggering flip-in rights. Thus, rights could separate at the 15% level, and become exercisable in common stock at the 40% or 50% level. A bidder would hesitate to move past the first threshold because the board's power to redeem the rights would terminate, and the bidder would be unable either to negotiate a friendly transaction or effect a change in the board that would allow redemption of the rights. There are several legal problems with this strategy that would preclude its use in some jurisdictions. If a hostile bidder moves through the first threshold, thus making the rights non-redeemable, the board may be locked into a position where it cannot redeem the rights or effectively negotiate with certain other bidders for the balance of the ten-year life of the rights plan. This was the essence of the rights plan of NL Industries, Inc. that was successfully challenged by Harold Simmons under New Jersey law. Recent Delaware decisions concerning “dead hand” and “slow hand” rights plans that limit or precluded boards from redeeming rights also raise troubling questions about the viability of this strategy.

Thus far this discussion has focused exclusively on the impact of a rights plan on the first stage in a hostile takeover—the acquisition of a controlling interest but less than all of the shares of the target. The second stage—the “takeout merger”—is restricted by the “flip-over” feature of the standard rights plan, which makes the rights exercisable in the bidder's stock on the same bargain basis as the flip-in rights previously provided. Standard rights, as observed earlier, provide a fixed profit for the rights holder upon exercise. The analysis does not change in the event of a merger in which the rights flip over. Using our example in Table 1, the rights simply become exercisable for $80 worth of bidder stock rather than target stock.

Why do conventional rights plans have surprisingly modest power? First, the relatively high exercise price, typically at 50% of market, has the effect of causing one-half of the shares subject to the rights to be issued at full market value, leaving a much smaller number of diluting shares. Second, low thresholds for the exercise of rights mean that the bidder's initial investment that is subject to dilution is relatively small. Third, as the target's stock price rises over time, the number of shares to be issued per right can decline and further reduce the dilutive effect of exercise.

Some of the solutions are elementary. First, there is no magic about an exercise price set at 50% of market value; setting it at 10% or 20% of market value provides much more power, as Table 3 demonstrates. While free shares would be even better, such large distributions would be treated as stock dividends, which would pose several legal problems. Such a dividend would be discriminatory, and while there is precedent for discriminatory treatment of bidders, each variation creates new uncertainties. Furthermore, in many jurisdictions, a stock dividend would require an assignment of surplus, which may not be available in the huge amounts necessary for a dividend of this size.

Second, difficulties with increasing the ownership level at which rights become exercisable have been described herein. The price for increasing the amount of bidder investment subject to dilution is an increase in the bidder's control and an increase in the likelihood that the bidder might gain an effective veto over a competing bid.

Third, if the exercise price is fixed in advance, increases in market value of shares will erode the number of dilutive shares that can be issued. While a board can adjust the exercise price, and thus the number of shares of common stock to be purchased, prior to a distribution date, most boards fail to do this, and once a bidder has triggered the rights this power no longer exists in related arts plans.

In order to cure these problems, the inventors abandoned the related art preferred stock rights plans as unduly complex and contributing nothing to the dilutive effect of rights, and simply issue rights to purchase common stock. In order to assure continuing dilutive power, we simply specify the number of common shares per right that can be purchased and specify a percentage discount from the market price of the shares as the exercise price. As the bidder's ownership increases, more shares are issued per remaining right, to assure dilution of the bidder's ownership to a very low level. We eliminate the unnecessary step of having rights first exercisable in preferred stock, and simply provide the right to purchase common stock. We explain the operation of this feature in the next section.

Additionally, the related art standard preferred stock rights plan is a muzzle loader that is, it fires once, and then allows the enemy to attack during the hiatus while the defender considers whether to reload his rifle, checks to see if his powder is dry, and then proceeds with the reloading process. The related art standard rights plan grants a shareholder a single right to purchase a single unit of preferred stock. It only provides for dilution of the bidder's initial investment to reach the triggering threshold, which, as we have demonstrated, is typically a relatively modest amount.

There is nothing to prevent a target board from adopting a new rights plan immediately after flip-in or common stock rights are triggered and creating the same increased costs for a bidder except for the judicial review problems created by a hasty adoption of a second or third rights plan. The lesson of current Delaware law, from a target board's standpoint, is that adopting a rights plan before any threat appears obtains the maximum deference for the board's decision. The board, with help from its advisers, can simply imagine all the possible threats a bidder might pose and adopt a rights plan to protect against all of them. Once a bidder appears, the Delaware Chancery Court is likely to be far more skeptical about the “threats” posed by a bidder. Where a bid is not structurally coercive, as in the case of a two-tier bid (and today none are), the only remaining threat is “substantive coercion”—that the price is too low, and that naïve shareholders will be fooled into tendering. In Chesapeake Corporation v. Shore, Vice Chancellor Strine exhibited considerable skepticism about such claims. In response to the target's claims that the market had not yet fully appreciated all its innovations and its improved prospects for the future, the court rejected implicit claims of market inefficiency, noting that the target's shares were largely owned by sophisticated institutional investors, that it was followed by analysts, and that analysts had discussed all of the innovations in their reports. All of these difficulties are avoided by adopting a plan on a “clear day,” when no bidder has yet appeared.

As explained in detail above, there are several problems with the related art shareholders rights plan when examined under a dynamic model. Particularly, it does not provide enough dilution to minimize hostile takeovers. Accordingly, there is a need for a shareholders rights plan that avoids these problems with the related art.

This invention provides solutions to the modest dilutive effects of the related art rights plan. Specifically, when a company is undervalued, the related art rights plan's relatively modest addition to costs does not deter a hostile acquisition. If proxy fights and litigation fail, why is it that no pills have been swallowed? One explanation is that all companies have a “shadow pill”—the ability to adopt a rights plan quickly, which serves as an effective deterrent to bidders; however, the inventors question whether that remains true in the heat of a takeover battle given the skepticism of Delaware courts and perhaps other courts about the hasty adoption of last minute takeover defenses.

### SUMMARY OF THE INVENTION

Accordingly, the present invention is directed to a reload rights plan for preferred and common stock that substantially obviates one or more of the problems due to limitations and disadvantages of the related art.

An advantage of the present invention is to provide a more powerful rights plan based on the observation that destruction of all of the bidder's initial investment will not deter all bidders.

Another advantage of the present invention is to provide a rights plan that reloads after rights first become exercisable, and that repeats its dilutive action automatically whenever a bidder buys sufficient stock to trigger the rights.

Another advantage of the present invention is to provide reductions in the exercise price and a formula that increases the number of shares issuable per right as the bidder's ownership increases and give power to rights plans.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, reloadable subsequent rights are used to provide a deterrent.

In another aspect of the present invention, providing a method of minimizing the potential for an unsolicited acquisition of a company by issuing rights of the company as pro rata distributions, wherein the rights include initial common stock rights and subsequent common stock rights; exercising the initial rights, wherein the initial rights enable a stockholder to purchase a first predetermined number of common stock shares at a discount price; exercising the subsequent rights, wherein the subsequent rights enable the stockholder to purchase a second predetermined number of common stock shares at the discount price; and continuously reloading the subsequent rights, wherein the subsequent rights become exercisable every time a person acquires a substantial block of shares of the company.

In another aspect of the present invention, a method of preparing a shareholders rights plan of a company, including drafting a first provision for issuing rights as pro rata distributions to all common stockholders of the company; drafting a second provision for exercising the initial rights, wherein the initial rights enable the common stockholders, other than the bidder, to purchase a first predetermined number of common stock shares at a discount price; drafting a third provision for exercising the subsequent rights, wherein the subsequent rights enable the stockholder and holder of a previously unexercised rights certificate to purchase a second predetermined number of common stock shares of the company at the discount price; and drafting a fourth provision for continuously reloading the subsequent rights.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention, and together with the description serve to explain the principles of the invention.

In the drawings:

FIG. 1 is a flow chart illustrating a related art shareholders rights plan; and

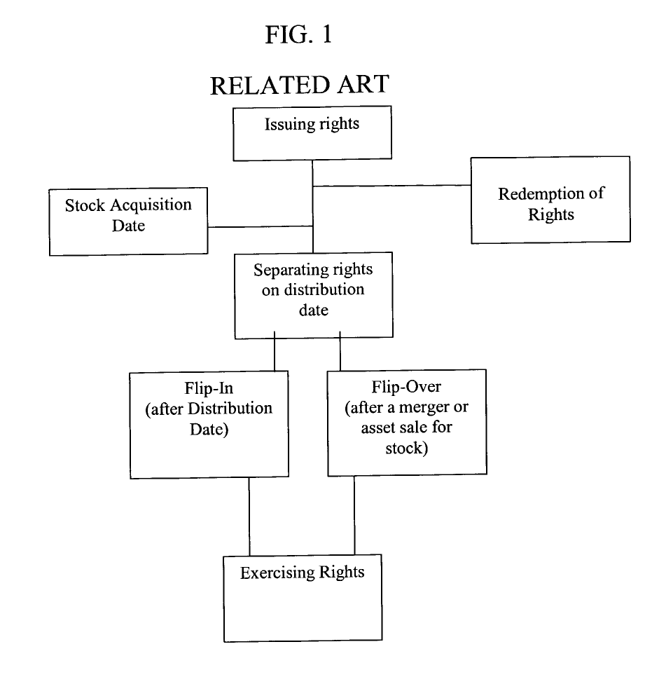

FIG. 2 is a flow chart illustrating a shareholders rights plan according to an embodiment of the present invention.

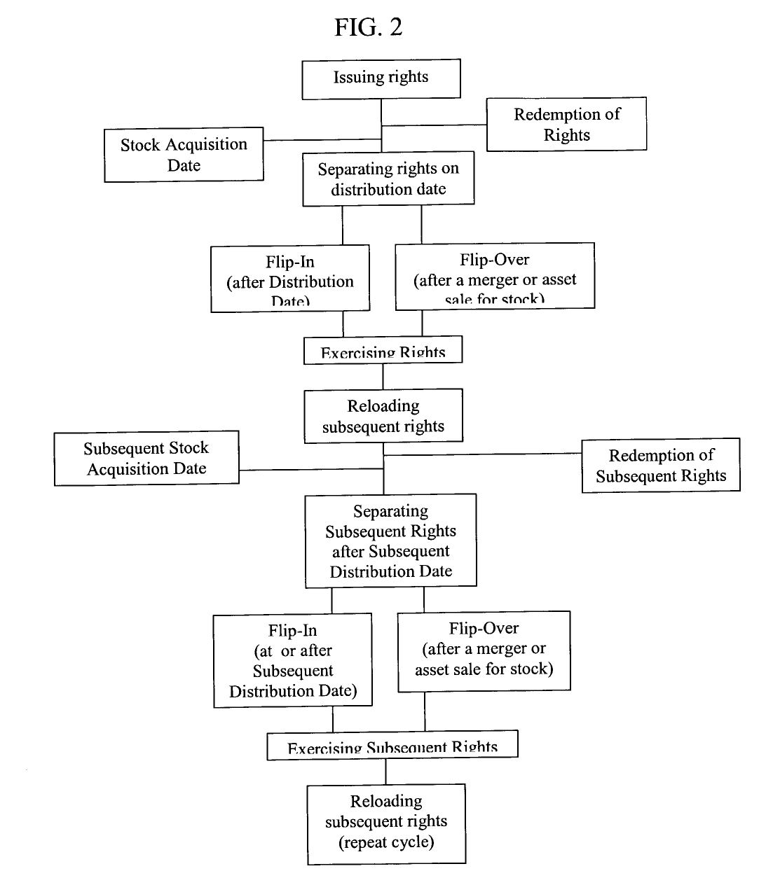

### DETAILED DESCRIPTION OF THE ILLUSTRATED EMBODIMENTS

Reference will now be made in detail to embodiments of the present invention, example of which is illustrated in the accompanying tables and formulas.

An exemplary embodiment of the present invention includes a “Reload” or “Timed Release Capsule” poison pill. The Reload Rights Plan applies to both preferred stock rights and common stock rights plans. References herein to common stock rights are deemed to also reference preferred stock rights.

The Reload Rights Plan deals with the problem posed by the relatively small amount of the bidder's investment that can be diluted with conventional thresholds by offering a plan that “reloads” should a bidder continue its attempt to acquire control after a first dilutive event. There is nothing to prevent multiple reloads of this plan, although continuous reloads are illustrated in the examples. Accordingly, a company having a plan with multiple reloads may assure that no bidder could afford to acquire the company without first negotiating a satisfactory price with the target's board. The potential dilution could become infinite. One advantage of a rights plan that provides for reloads is that it clearly signals to the bidder that dilution, and thus the bidder's costs, will be maximized. Nevertheless, the Reload Rights Plan permits the target company's board of directors to redeem outstanding untriggered rights if the board has determined that the price and terms offered by the bidder in its takeover attempt are fair to the target company's stockholders.

There are four parts to this plan. The first part is to reduce the exercise price for the rights, so the discount is greater than 50%. There is nothing sacrosanct about the conventional 50% discount. In this embodiment a 20% discount is employed on several occasions. In this way the “p” (proceeds) in Equation (1) can be reduced, which increases the dilution suffered by the bidder. This reduction has the corresponding negative effect, from the target's perspective, of increasing the percentage premium that the bidder's offer represents discussed above.

The second part of the rights plan of the present embodiment is to specify the number of shares of common stock to be purchased with each right as an absolute number. For purposes of illustration only, 10 shares of common stock per right are specified. The calculations below use a market price of $15.00 per share when the rights become exercisable, leading to an exercise price of $3.00 for 10 shares, for proceeds of $30.

Third, to assure that any exercise of the rights would place the bidder below the triggering threshold once again, a formula that increases the number of shares to be purchased as the bidder acquires greater amounts of the target stock is employed. This is shown in Equation (3):

$$R = \frac{x}{x - a} . \qquad Equation ( 3 )$$

Where R=the number of target shares for which a right is initially exercisable.

This increases the total dilution the bidder suffers in the unlikely event of a maximum purchase (increases in dilution over the preferred stock plan are modest for minimum acquisitions at lower percentages). For example, if the rights are initially exercisable to purchase 10 shares once the bidder owns 15% of the target's shares, the plan would provide that each right is exercisable for:

$$R = ( 10 ) \frac{( 1 , 000 , 000 )}{1 , 000 , 000 - 150 , 000} = 11.764 shares per right$$

Use of this formula has the effect of increasing the number of shares that can be purchased by the remaining public shareholders as the bidder's ownership increases. This formula holds the total number of shares to be issued for the rights constant regardless of the bidder's percentage of ownership. Because, in our example, the rights would be based on the issuance of ten times as many shares as are currently outstanding, exercise of the rights would always put the bidder back below 10% on a fully diluted basis. In our example, the rights would always be exercisable for 10,000,000 shares, regardless of the number of rights outstanding in the hands of the public shareholders. This can be demonstrated by assuming acquisition of 95% of all shares by the bidder:

$$R = ( 10 ) \frac{( 1 , 000 , 000 )}{1 , 000 , 000 - 950 , 000} = 200 shares per right$$

With 11,000,000 fully diluted shares outstanding, the bidder's ownership is reduced to 8.6%, well below any threshold that is likely to be selected for a rights plan.

Fourth, a reload feature may be included in the plan. The rights will “reload” each time the bidder crosses the 15% threshold. Except for the 80% discount from market price and the right to purchase ten shares, the assumptions remain as stated in Table 1. Thus, the formula for the number of shares for which a right can be exercised remains the same. It is assumed once again that a bidder will seek to minimize its dilution by investing the minimum amount necessary to trigger exercise of the rights.

The effects of minimum acquisition necessary to trigger the rights are described. While there are no theoretical limits to the number of times a rights plan can reload, for the purposes of our example, the calculations are limited to a single reload, followed by a complete acquisition by the bidder. It is assumed that the bidder acquires the initial 15% as before and is diluted as before. Then we assume the bidder acquires sufficient fully diluted shares to once again reach 15%, only to be diluted again, before acquiring all remaining shares in an any and all tender offer followed by a takeout merger at the same price—50% premium over the pre-acquisition market price (adjusted for dilution). Equation (4) demonstrates the bidder's expected costs of returning to a 15% ownership position after an initial dilution.

$$L = ma - \frac{( mx + p )}{x + d} ( a ) + {m}^{′} {a}^{′} - \frac{( {m}^{′} {x}^{′} + {p}^{′} )}{{x}^{′} + {d}^{′}} {( a )}^{′} . \qquad Equation ( 4 )$$

where primes indicate the second transaction.

Because this rights plan always issues rights for ten times as many fully diluted shares as are currently outstanding, (including shares available upon exercise of unexercised rights that have separated on a distribution date or subsequent distribution date), the percentage dilution of the bidder's minimum investment remains constant each time the rights are triggered. Because the example assumes receipt of the proceeds from exercise, the investment necessary to acquire 15% rises with each round, thus increasing the investment available for dilution, as illustrated in Table 6 using a second triggering of the rights:

TABLE 6
Bidder's Cost of a Minimum Acquisition Using a Two-Tier Reload Plan

| | |
|---|---|
| Creeping tender offer for 150,000 shares at | $2,250,000 |
| $15.00/share = | |
| Rights are triggered for 11.764705 shares for 850,000 | |
| rights | |
| Shares Outstanding: | |
| New shares | 10,000,000 |
| Original shares | 1,000,000 |
| Total shares | 11,000,000 |
| Proceeds of exercise: (850,000 × $35.2941) = | $30,000,000 |
| Market's estimate of value of target: | $45,000,000 |
| Value per fully diluted share: ($45,000,000/11,000,000): | $4.0909 |
| Value of bidder's 150,000 shares: | $613,636 |
| Bidder's dilution losses in 1^{st} tier: | $1,636,363 |
| Bidder's cost for a 15% acquisition (1,500,000 × | $6,136,363 |
| $4.0909) = | |
| Rights are triggered for 11.76 shares for 9,350,000 rights | |
| Shares Outstanding: | |
| New Shares | 110,000,000 |
| Previous shares | 11,000,000 |
| Total shares | 121,000,000 |
| Proceeds of exercise: (9,350,000 × $9.62566) = | $90,000,000 |
| Market's estimate of total value of target: | $135,000,000 |
| Value per fully diluted share: | $1.1157 |
| Value of bidder's 1,650,000 shares: | $1,840,909 |
| Bidder's dilution losses in 2d tier: | $4,909,091 |
| Bidder's cost forremaining shares (119,350,000 × | $133,159,091 |
| $1.1157) = | |
| Total Cost to Bidder | $141,545,454 |

The increase in value of the target with each round raises the bidder's costs of acquisition by 15% each round, thus providing a greater amount of investment subject to dilution. While this target may well have the entire proceeds available for the bidder recapture through a dividend after the bidder completes the acquisition ($120,000,000), this does not reduce the bidder's losses through dilution. Assuming the market value of the target at the end is the original value of $15,000,000 plus the proceeds of exercise, it is only $135,000,000, leaving the bidder with dilution losses of $6,545,454 (and a corresponding increase in the cost of acquisition) on its first two rounds of investment. These losses will continue to escalate on succeeding rounds. Thus, if we exclude the bidder's cost for the remaining shares in Table 6, above, the third round of dilution is as follows:

| | |
|---|---|
| Bidder's cost for a 15% acquisition (16,500,000 × | $18,409,050 |
| $1.1157) = | |
| Rights are triggered for 11.764705 shares for | |
| 102,500,000 rights | |
| Shares Outstanding: | |
| New shares | 1,205,882,262 |
| Previous shares | 121,000,000 |
| Total shares | 1,326,882,262 |
| Proceeds of exercise: (102,500,000 × $2.6251) = | $269,080,568 |
| Market's estimate of total value of target: | $404,080,568 |
| Value per fully diluted share: | $0.30453 |
| Value of Bidder's 18,150,000 shares: | $5,527,289 |
| Bidder's dilution losses in 3d tier: | $14,722,666 |
| Bidder's cost for remaining shares (1,308,732,262 × | $399,726,094 |
| $0.30543) = | |
| Total Cost to Bidder | $426,521,507 |

Thus, total dilution losses from three rounds are $21,268,120, which provides a 213% premium over the original $10 million market value of the target.

The reload feature requires an enormous number of authorized but unissued shares to be effective. Because most corporations will lack this number, it will probably be necessary to employ small fractions of shares of a new series of blank check preferred, a feature of some current conventional plans, in order to have sufficient units.

The Reload Rights Plan provides that once the initial common stock rights have become exercisable, both the shares of common stock and the unexercised initial common stock rights represent inchoate rights to purchase additional shares of stock upon the occurrence of a “Subsequent Stock Acquisition Date,” which means the date when a person (whether an original “Acquiring Person” (the beneficial owner or deemed beneficial owner of the triggering amount of stock) or another person) again acquires an accumulated amount of common stock at least equal to the triggering percentage.

Additionally, the Reload Rights Plan provides that a person's status as an Acquiring Person ceases when the person's ownership of common stock falls below the triggering amount, which then permits the Company's board of directors to redeem inchoate “Subsequent Rights,” for which certificates would have issued upon the occurrence of a Subsequent Stock Acquisition Date.

“Subsequent Rights” exist after an “Initial Rights Distribution Date” (the date when the target company distributes to its stockholders Initial Rights), and certificates for Subsequent Rights are issueddistributed (“Subsequent Rights Distribution Date”) on the or after the earlier of (i) “Subsequent Stock Acquisition Date,” the date on which a person again acquires the triggering amount of common stock, or (ii) announcement of a tender offer that could result in a person owning a specified triggering amount of common stock subsequent to an “Initial Stock Acquisition Date.”

Subsequent Rights are, prior to a “Subsequent Rights Distribution Date,” represented by certificates for the common stock of the company and unexercised “Previous Rights Certificates,” which were issued for rights on a “Previous Distribution Date.”

The number of shares for which a right is exercisable increases in proportion to the percentage of outstanding shares of common stock owned by an Acquiring Person, so that the number of shares issued with respect to outstanding rights remains constant, regardless of the percentage of common stock owned by shareholders other than an Acquiring Person as shown in Equation (3).

Subsequent Rights are redeemable by the company until a “Subsequent Rights Distribution Date,” which generally will be a specified period following a Subsequent Stock Acquisition Date.

Additionally, the Reload Rights Plan may provide that the board of directors of a company may, at its option, at any time prior to the close of business on a specified business day following the Initial Stock Acquisition Date, generally the Initial Distribution Date, redeem all but not less than all of the then outstanding Initial Rights (other than rights that have become void pursuant to the Rights Plan) at a predetermined redemption price per right (the “Redemption Price”), as such amount may be appropriately adjusted pursuant to the Rights Plan).

Further, the Reload Rights Plan may provide that the Board of Directors may, at its option, at any time prior to the close of business on a specified business day following a Subsequent Rights, distribution, generally the related Subsequent Rights Distribution Date, redeem the Subsequent Rights (other than Rights that have become void pursuant to the Reload Rights Plan) at the Redemption Price as such amount may be adjusted pursuant to the Reload Rights Plan. Notwithstanding anything to the contrary, if the Reload Rights Plan elects this feature, Rights shall not be exercisable until such time as the Company's right of redemption therefor has expired.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of minimizing the potential for an unsolicited acquisition of a company, upon terms unacceptable to its board of directors, comprising:
issuing rights as pro rata distributions to all common stockholders of the company upon approval by a board of directors of a shareholders rights plan, wherein the rights include initial rights and subsequent rights, wherein the rights are deemed attached to certificates for then issued and outstanding shares of common stock and are attached to subsequently issued new common stock certificates by affixing a notation incorporating the rights by reference to the shareholders rights plan, and wherein the rights are not immediately exercisable on issuance;
separating the initial rights from the common stock certificates on or after a first triggering event, wherein the initial rights enable a common stockholder to purchase a first predetermined number of common stock shares at a discount price;
separating the subsequent rights from the common stock certificates and unexercised previous rights certificates on or after a subsequent triggering event, wherein the subsequent rights enable a common stockholder to purchase a second predetermined number of common stock shares at the discount price; and
continuously reloading the subsequent rights upon each subsequent triggering event and repeating issuance of subsequent rights every time a subsequent triggering event thereafter occurs.

2. The method of minimizing the potential for an unsolicited acquisition of a company, upon terms unacceptable to its board of directors of claim 1, wherein the discount price is approximately equal to a predetermined percentage multiplied by a current market price for the common stock of the company.

3. The method of minimizing the potential for an unsolicited acquisition of a company, upon terms unacceptable to its board of directors of claim 2, wherein the predetermined percentage is in the range from greater than zero to less than one hundred percent.

4. The method of minimizing the potential for an unsolicited acquisition of a company, upon terms unacceptable to its board of directors of claim 3, wherein the predetermined percentage is fifty percent (50%).

5. The method of minimizing the potential for an unsolicited acquisition of a company, upon terms unacceptable to its board of directors of claim 3, wherein the predetermined percentage is twenty percent (20%).

6. The method of minimizing the potential for an unsolicited acquisition of a company, upon terms unacceptable to its board of directors of claim 3, wherein the current market price is to be employed in determining at least one of the following: (i) a number of shares to be purchased for a fixed exercise price and (ii) in determining a price from which a discounted exercise price is measured.

7. The method of minimizing the potential for an unsolicited acquisition of a company, upon terms unacceptable to its board of directors of claim 1, wherein the first trigger event occurs on at least one of the following: (i) when an acquiring person acquires a substantial block of common stock of the company and (ii) when the acquiring person makes a tender offer for a substantial block of common stock of the company.

8. The method of minimizing the potential for an unsolicited acquisition of a company, upon terms unacceptable to its board of directors of claim 7, wherein the substantial block of common stock is 5% or more of then issued and outstanding shares of common stock of the company.

9. The method of minimizing the potential for an unsolicited acquisition of a company, upon terms unacceptable to its board of directors of claim 7, wherein the substantial block of common stock is 10% or more of then issued and outstanding shares of common stock of the company.

10. The method of minimizing the potential for an unsolicited acquisition of a company, upon terms unacceptable to its board of directors of claim 7, wherein the substantial block of common stock is 15% or more of then issued and outstanding shares of common stock of the company.

11. The method of minimizing the potential for an unsolicited acquisition of a company, upon terms unacceptable to its board of directors of claim 7, wherein the subsequent triggering event occurs after the first triggering event and on at least one of the following: (i) when an acquiring person acquires a substantial block of common stock of the company and (ii) when the acquiring person makes a tender offer for a substantial block of common stock of the company.

12. The method of minimizing the potential for an unsolicited acquisition of a company, upon terms unacceptable to its board of directors of claim 11, wherein the substantial block of common stock is greater than (15%).

13. The method of minimizing the potential for an unsolicited acquisition of a company, upon terms unacceptable to its board of directors of claim 1, wherein the first predetermined number of common stock shares is equal to a fraction multiplied by a number, wherein the fraction includes a numerator and denominator, the numerator includes a number of shares of common stock of the company outstanding on the second triggering event, wherein there is a first public announcement that a bidder has acquired beneficial ownership of a specified percentage of company's issued and outstanding shares of common stock, and the denominator includes a number of shares of common stock of the company outstanding on the date of the second trigger event that are not owned by an acquiring person.

14. The method of minimizing the potential for an unsolicited acquisition of a company, upon terms unacceptable to its board of directors of claim 13, wherein the second predetermined number of common stock shares is equal to a fraction multiplied by a number, wherein the fraction includes a numerator and denominator, the numerator includes a number of shares of common stock of the company outstanding plus the number of shares subject to unexercised previous rights on a subsequent stock acquisition date and the denominator includes a number of shares of common stock of the company outstanding plus the number of shares subject to unexercised previous rights on a subsequent stock acquisition date that are not owned by an acquiring person.

15. The method of minimizing the potential for an unsolicited acquisition of a company, upon terms unacceptable to its board of directors of claim 14, wherein the number is a whole integer.

16. The method of preparing a shareholders rights plan with continuously reloadable subsequent rights according to claim 1.

17. The method of minimizing the potential for an unsolicited acquisition of a company, upon terms unacceptable to its board of directors of claim 1, further comprising:
exercising initial rights and subsequent rights, wherein the exercised rights are insufficient to cause a bidder to no longer be deemed an acquiring person on the basis of a bidder's beneficial ownership of shares of common stock of the company, the bidder proceeds to acquire a predetermined additional percentage of the company's issued and outstanding shares, causing an issuance of an additional set of subsequent rights.

18. A method of preparing a shareholders rights plan for minimizing the potential of an unsolicited acquisition of a company, upon terms unacceptable to its board of directors, comprising:
drafting a first provision for issuing rights as pro rata distributions to all common stockholders of the company upon a board of directors approving the shareholders rights plan, wherein the issued rights include initial rights and subsequent rights and the issued rights are deemed attached to certificates for then issued and outstanding shares of common stock and are attached to subsequently issued new common stock certificates by affixing a notation incorporating the rights by reference to the shareholders rights plan, and the rights are transferable only with the common stock certificates and are not immediately exercisable on issuance;
drafting a second provision for distribution of separate certificates for the rights, to the stockholders of the company to be issued on a distribution date, triggered by at least one of the following: (i) acquisition of beneficial ownership of a predetermined percentage of issued and outstanding shares of common stock of the company and (ii) announcement of a tender offer that could result in beneficial ownership of a predetermined percentage of issued and outstanding shares of common stock of the company;
drafting a third provision for exercising the initial rights from the separate certificates on or after acquisition of beneficial ownership of a predetermined percentage of the issued and outstanding shares of common stock of a company by an acquiring person, wherein the initial rights enable the stockholder to purchase a first predetermined number of common stock shares at a discount price;
drafting a fourth provision for issuing subsequent rights certificates, to holders of common stock of the company and to holders of initial rights certificates that have not been exercised, wherein the subsequent rights will be issued on a distribution date, wherein the distribution date is triggered by at least one of the following: (i) acquisition of beneficial ownership of a predetermined percentage of issued and outstanding shares of common stock of the company and (ii) announcement of a tender offer that could result in beneficial ownership of a predetermined percentage of issued and outstanding shares of common stock of the company;
drafting a fifth provision for exercising the subsequent rights, wherein the subsequent rights enable the stockholders of common stock of the company and the stockholders of previously unexercised rights certificates to purchase a subsequent predetermined number of common stock shares at a discount price; and
drafting a sixth provision for continuously reloading the subsequent rights, wherein the subsequent rights become exercisable every time a subsequent triggering event thereafter occurs.

19. The method of preparing a shareholders rights plan for minimizing the potential of an unsolicited acquisition of a company, upon terms unacceptable to its board of directors of claim 18, wherein the shareholders rights plan is a preferred stocks rights plan.

20. The method of preparing a shareholders rights plan for minimizing the potential of an unsolicited acquisition of a company, upon terms unacceptable to its board of directors of claim 18, wherein the shareholders rights plan is a common stock rights plan.

21. The method of preparing a shareholders rights plan for minimizing the potential of an unsolicited acquisition of a company, upon terms unacceptable to its board of directors of claim 1, further comprising:
converting the right to purchase shares of the common stock of the company into shares of any other entity, shares of which are publicly traded, for protecting the rights' value from destruction upon any one of the following: merger with the entity, consolidation with the entity, share exchange with the entity, sale of assets to the entity, sale of substantially all assets to the entity, and sale of all assets to the entity.

22. The method of preparing a shareholders rights plan for minimizing the potential of an unsolicited acquisition of a company, upon terms unacceptable to its board of directors of claim 21, wherein the entity includes an affiliate of the entity.

23. A method of preparing a preferred stock shareholders rights plan, comprising:
drafting a first provision for issuing preferred stock purchase rights as pro rata distributions to all common stockholders of the company, wherein the preferred stock rights allows the common stockholders to purchase a unit of preferred stock at a predetermined exercise price prior to the first triggering event;
drafting a second provision for issuing preferred stock rights as pro rata distributions to all common stockholders of the company upon a board of directors approving terms of the preferred stock, wherein the issued rights are deemed attached to certificates for then issued and outstanding shares of common stock and are attached to subsequently issued new common stock certificates by affixing a notation incorporating the rights by reference to the shareholders rights plan;
drafting a third provision for separating the initial rights and subsequent rights from the common stock certificates on and after a first triggering event;
drafting a fourth provision for exercising initial converted common stock rights on or after a second triggering event, wherein the initial rights permit the stockholder to purchase a first predetermined number of common stock shares at a discount price;
drafting a fifth provision for exercising subsequent converted common stock rights of the company, wherein the subsequent rights enable a common stockholder and previous unexercised rights certificate holder to purchase a second predetermined number of common stock shares at the discount price; and
drafting a sixth provision for continuously reloading the subsequent flip-in common stock rights, wherein the subsequent flip-in common stock rights become exercisable every time a subsequent triggering event thereafter occurs.

24. The method of preparing a preferred stock shareholders rights plan of claim 23, wherein initial flip-in common stock rights are for a sufficient number of shares to enable the rights holder to purchase a sufficient number of shares of common stock at an exercise price to permit the purchase to be at a predetermined discount from the current market value.

25. The method of preparing a preferred stock shareholders rights plan of claim 24, wherein the predetermined percentage is in the range of greater than zero to less than hundred percent.

26. The method of preparing a preferred stock shareholders rights plan of claim 25, wherein the predetermined percentage is twenty percent (20%).

27. The method of preparing a preferred stock shareholders rights plan of claim 23, wherein the first triggering event occurs on at least one of the following: (i) when an acquiring person acquires a substantial block of common stock of the company and (ii) when the acquiring person makes a tender offer for a substantial block of common stock of the company.

28. The method of preparing a preferred stock shareholders rights plan of claim 27, wherein the substantial block of common stock is greater than 15% of outstanding common stock of the company.

29. The method of preparing a preferred stock shareholders rights plan of claim 27, wherein the second triggering event occurs on or after the first triggering event and an acquiring person acquires a substantial block of common stock of the company.

30. The method of preparing a preferred stock shareholders rights plan of claim 23, wherein the first predetermined number of common stock shares is equal to a number of shares with a current market value equal to a multiple of the exercise price for each right.

31. The method of preparing preferred stock shareholders rights plan of claim 29, wherein the second predetermined number of common stock shares is equal to a number of shares with a current market value equal to a multiple of the exercise price for each right.

32. The method of exercising the preferred stock shareholders right plan of claim 28.

33. A method of minimizing the potential for an unsolicited acquisition of a company upon terms unacceptable to its board of directors, comprising:
issuing rights of the company as pro rata distributions, wherein the rights include initial common stock rights and subsequent common stock rights;
exercising the initial rights, wherein the initial rights enable a stockholder to purchase a first predetermined number of common stock shares at a discount price;
exercising the subsequent rights, wherein the subsequent rights enable the stockholder to purchase a second predetermined number of common stock shares at the discount price; and
continuously reloading the subsequent rights, wherein the subsequent rights become exercisable every time a person acquires a substantial block of shares of the company.

34. The method of preparing a shareholders rights plan of a company, comprising:
drafting a first provision for issuing rights as pro rata distributions to all common stockholders of the company;
drafting a second provision for exercising the initial rights, wherein the initial rights enable the common stockholders, other than the bidder, to purchase a first predetermined number of common stock shares at a discount price;
drafting a third provision for exercising the subsequent rights, wherein the subsequent rights enable the stockholder and holder of a previously unexercised rights certificate to purchase a second predetermined number of common stock shares of the company at the discount price; and
drafting a fourth provision for continuously reloading the subsequent rights.

35. A method of preparing a preferred stock shareholders rights plan of a company, comprising:
drafting a first provision for issuing, as pro rata distributions to all common stockholders of the company, rights to purchase preferred stock, wherein the preferred stock rights allows the common stockholders to purchase a unit of preferred stock at an exercise price prior to the first triggering event;
drafting a second provision for issuing rights as pro rata distributions to all common stockholders of the company;
drafting a third provision for exercising the initial rights, wherein the initial rights permit the stockholder to purchase a first predetermined number of common stock shares of the company at a discount price;
drafting a fourth provision for exercising the subsequent rights, wherein the subsequent rights enable the stockholder to purchase a second predetermined number of common stock shares of the company at the discount price; and
drafting a fifth provision for continuously reloading the subsequent rights.
